(19) United States
(12) Patent Application Publication
(10) Pub. No.: US 2026/0274150 A1
(43) Pub. Date: Sep. 17, 2026

(54) SHIPPING CONTAINER TWIST-LOCK SYSTEM

(71) Applicant: SPRING LOADED AND LOCKED PTY LTD, Port Melbourne, Victoria (AU)

(72) Inventor: Keven WATTERSON, Port Melbourne, Victoria (AU)

(21) Appl. No.: 18/869,078

(22) PCT Filed: May 26, 2023
(86) PCT No.: PCT/AU2023/050446

§ 371 Date: Nov. 25, 2024

(30) Foreign Application Priority Data
May 26, 2022 (AU) 2022901425

(51) Int. Cl. B60P 7/13; B61D 45/00; B65D 90/00

(52) U.S. Cl. CPC B60P 7/132; B61D 45/007; B65D 90/0013; B65D 2590/0025

(57) ABSTRACT

A twist-lock system for locking a shipping container to a truck trailer or to a rail transport vehicle is disclosed. The twist lock system comprises a twist-lock (10) that is mountable to a truck trailer or rail transport vehicle and includes a rotatable locking element (60) linked to a driver (40) that causes the locking element (60) to rotate for locking and unlocking the twist-lock with a shipping container. The driver (40) is configured to operate upon receiving an input signal from a location remote from the twist-lock via a remote hand-held device (100). Also disclosed is a truck trailer including such twist-locks and a remotely actuated twist-lock system. A twist-lock for locking a first shipping container to a second shipping container is also disclosed.

### TECHNICAL FIELD

The present invention relates to shipping container transportation.

In particular, although not exclusively, the present invention relates to securing a shipping container to another structure.

The term “structure” in the context of a shipping container is understood herein to mean any object that is capable of supporting or otherwise interacting with the shipping container. By way of example, the structure may be another shipping container or a truck trailer or a rail transport vehicle. By way of example, the structure may be another shipping container that is capable of being connected to the shipping container in side by side, end to end, or stacked, relationship and thereby interacting with the shipping container.

More particularly, although not exclusively, the invention relates to twist-locks that are fitted to a trailer of a transport vehicle and which lock together the shipping container and the trailer.

More particularly, although not exclusively, the invention relates to twist-lock systems for locking together shipping containers in either a side by side relationship, an end to end relationship, or one shipping container on the other shipping containing in a stacked relationship.

A “twist-lock” is a device that secures a shipping container, typically, although not exclusively, to a truck trailer or another shipping container in a stacked arrangement.

The twist-lock will be described in the context of road transport by truck trailer, but it will be appreciated that the invention has broader application.

### BACKGROUND

Shipping containers include a locking point at least at each lower corner and at corresponding upper corner for securing the container during shipping. The upper locking points are used to lock a shipping container to another shipping container stacked on top or to a point on a ship. The lower locking points are used for the same purpose and, additionally, for securing the shipping container to a truck trailer for transporting the shipping container by road.

Devices fitted to truck trailers for locking to a shipping container are known as “twist-locks” for the way they operate. Twist-locks typically comprise a locking element configured to rotate between a locked and an unlocked position. The locking element typically has a locking head with an rotational asymmetrical profile (for example athletics track shaped) and a stem with a rotationally symmetrical profile. The locking element is rotatably coupled to the truck trailer. The locking head is configured to be received within an opening on the shipping container which forms part of the locking point and has a corresponding rotational asymmetric profile. The locking point also includes a cavity, also referred to as a locking recess, in communication with the opening and which defines a shoulder surrounding the opening. The twist-lock is operated by manually lifting the stem so that the head passes upwardly through the opening, and then rotating the stem so that the locking head overlaps the shoulder to thereby cause the twist-lock to mechanically lock with the locking point of the shipping container.

The twist-lock is formed so that the twisting action causes frictional locking of the stem in the rotated position i.e. with the locking head overlapping the shoulder. This prevents the twist-lock from releasing during transport of the container.

The manual process of locking each twist-lock ensures that the truck driver checks that each twist-lock is secured properly. Spending time at each twist-lock, however, exposes the truck driver to the risk of injury or death as a result of traffic, i.e. other trucks or container-loading vehicles such as cranes and container lift vehicles. The risks are ever-present and each year at container wharves around the world, truck drivers are injured and some are killed by traffic while securing a shipping container to a trailer.

It is desirable to reduce the extent to which truck drivers are exposed to risk while operating twist-locks.

The above description is not to be taken as an admission of the common general knowledge in Australia or elsewhere.

### SUMMARY OF THE DISCLOSURE

The present invention provides in one aspect a twist-lock system for locking a shipping container to a structure as described herein, the system including: (a) a twist-lock having a rotatable locking element, (b) a driver for causing the locking element to rotate for locking and unlocking the twist-lock to lock and unlock, respectively, the shipping container to the structure, and (c) a remote hand-held device for generating an input signal to operate the driver.

In the context of the present application, the term “system” refers to a collection of components that have an interworking relationship but that are not necessarily physically connected to each other.

The term “structure” in the context of a shipping container is understood herein to mean any object that is capable of supporting or otherwise interacting with the shipping container. By way of example, the structure may be another shipping container or a truck trailer or a rail transport vehicle. By way of example, the structure may be another shipping container that is capable of being connected to the shipping container in side by side, end to end, or stacked, relationship and thereby interacting with the shipping container.

A “shipping container” is understood herein to mean a container with strength suitable to withstand shipment, storage and handling. The shipping container may be box shaped. An example of a box shaped shipping container is an intermodal container. Intermodal containers are generally made from corrugated steel. The general dimensions of an intermodal container are as follows: 8 feet wide (2.4 m), between 4 feet (1.2 m) and 10 feet (3 m) in height and either: 20 feet (6.1 m) long; or 40 feet (12.2 m) long. In one specific example, an intermodal container is 8 feet wide (2.4 m), 8 feet, 6 inches (2.6 m) high and 20 feet long (6.1 m). In another specific example, an intermodal container is 8 feet wide (2.4 m), 9 feet, 6 inches (2.9 m) high and 20 feet long (6.1 m).

However, the twist-lock system according to some embodiments of the present invention may also be suitable for other shaped shipping containers such as cylindrical shaped shipping containers, i.e. drums.

The term “driver” is understood herein to mean a device for controlling powered movement of another object. Powered movement is understood to mean the opposite of manual movement, i.e. hand operated. The driver may be an actuator, such as a motor. The driver may include a controller for controlling operation of the actuator. The driver may include a power supply for powering the actuator.

The term “locking element” is understood herein to mean a part of a lock which is operable to lock and unlock the lock.

The locking element may comprise a locking head and a stem.

The locking head may have a rotationally asymmetrical profile.

The locking stem may have a rotationally symmetrical profile.

“Rotational symmetry” is understood to mean that an object looks the same after some rotation (of less than one full turn) as it did at its starting point.

A “remote hand-held device” is understood to mean of stand-alone computer or processing unit that is portable or capable of being repositioned from one location to another. The remote hand-held device may be a generic processing device such as a smartphone, tablet or laptop. An advantage to using a generic processing device is that it negates the requirement for a dedicated processing device. It is also conceived that the remote hand-held device may be a control panel or another dedicated processing device.

The input signal may be transmitted to the driver via a wireless or wired connection.

The input signal may be generated via an app on the remote hand-held device. The app may comprise a graphical user interface (GUI).

In some embodiments, the remote hand-held device may be operated from a location remote from the twist-lock, for example a cabin of a truck coupled to a trailer. In such embodiments, the remote operation of the twist-lock removes safety concerns associated with a truck driver visiting each twist-lock around a trailer and manually operating each twist lock. Given that there may be 4 or 8 twist-locks that require operation to secure a container (and in some cases, two shipping containers on a trailer), the truck driver is exposed to traffic, such as other trucks, forklifts or transporters carrying containers to a truck. Such exposure places the truck driver at risk of injury and death. Those risks are reduced by enabling the shipping container to be locked to the truck trailer without the driver leaving the cabin.

Remote operation of the twist-lock reduces the time required to lock a container to the truck trailer because all relevant twist-locks can be operated simultaneously. This results in a faster turn-around time for truck drivers in terms of loading and unloading shipping containers.

The twist-lock may include a locking lug which includes a collar to which the driver is connected such that the locking head is rotatable relative to the collar and the locking head and collar have the same profile of a locking recess on a shipping container so that the collar and the locking head are receivable in the locking recess.

The twist-lock may include a bracket in which the locking lug is mechanically locked and wherein the locking head and at least a portion of the collar project above an upper platform of the bracket.

The locking lug may be able to move generally vertically relative to the bracket and wherein the vertical movement is limited by the mechanical locking of the locking lug to the bracket and wherein the locking lug is biased upwardly relative to the bracket to cause the collar and locking head to project into the locking recess of a shipping container when the locking recess is aligned with the locking head and collar.

The upward bias may be provided by a coil spring disposed between the locking lug and the bracket.

Alternatively, the upward bias may be provided by a deformable element disposed between the locking lug and the bracket.

Alternatively, the upward bias may be provided hydraulically.

Alternatively, the upward bias may be provided pneumatically.

An advantage of biasing the locking lug is that the collar and locking head can be retracted under the weight of the shipping container so as to be protected from damage during loading. In addition, the biasing of the locking lug allows the collar and locking head to automatically return to their initial position, once the weight of the shipping container is removed, to allow locking when the shipping container is properly aligned. In practice, this means that biasing the locking lug eliminates the need for manual readjustment in order to set up for either a 20 ft or a 40 ft long container. Typically, twist-locks known in the art have to be manually raised in order for them to be set up for locking with the container.

The upper platform may include a downwardly depending sleeve having an inner profile that guides generally vertical movement of the collar within the sleeve, and therefore guides generally vertical movement of the locking lug within the bracket.

The driver may be configured to cause rotation of the locking head between an unlocked position in which its profile is aligned with the profile of the collar to an unlocked position in which the profiles of the collar and the locking head are generally perpendicular.

The driver may include a pair of limit switches that limit rotation of the locking head to the locked and unlocked positions.

The twist-lock may include a position indicator that indicates to a user, for example a truck driver, the rotational position of the locking element and therefore the locked or unlocked condition of the twist-lock.

The position indicator may be a visual position indicator, i.e. that indicates to the user the rotational position of the locking element via visual information.

For example, the visual position indicator may include an arm linked to the driver to rotate in unison with the locking head and wherein the arm is configured to provide a visual indication of the rotational position of the locking head. The arm may be configured to be visible from the cabin of a truck linked to a truck trailer when the locking head is in an unlocked position.

The position indicator may be an electronic position indicator, i.e. that generates an electrical signal, based on the rotational position of the locking element, that is used in an electronic device to communicate to the user whether twist-lock is in the locked or unlocked condition.

The electronic position indicator may comprise a switch, such as a Reed switch or a Hall switch, and an alarm, such as a light source or an electroacoustic transducer (speaker or siren). The switch and alarm may be configured such that closing or opening the switch triggers the alarm to alert the user of the change in condition of the twist-lock.

The structure may include a mount that engages with a part of the twist-lock. In some embodiments, the mount includes a locking recess that receives the locking head. The locking recess may have an opening which conforms to the profile of the locking head.

The twist-lock may be disposed on a rail transport vehicle such that the twist-lock enables locking of the shipping container to the rail transport vehicle.

The twist-lock may be disposed on a truck trailer such that the twist-lock enables locking of the shipping container to the truck trailer.

The system may comprise an actuator that send an input signal to the twist-locks via a wired or wireless communication to operate the respective drivers and an input terminal that is remote from the twist-locks and which receives inputs from a truck driver and transmits an operation signal to the actuator whereby to operate the respective drivers to lock or unlock a shipping container with the truck trailer.

The input terminal may be a control panel.

The input terminal may be located in the cabin of a truck and is in communication with the twist-locks.

The system may include an actuator on the truck trailer that receives a signal from the input terminal and sends input signals to the twist-locks to operate the respective drivers.

The twist-locks may provide a status feedback signal to the input terminal, optionally via the actuator, to indicate a status condition of a twist-lock.

The status condition may be whether the locking head is in the locked or unlocked position.

The twist-lock may be disposed on a container such that the twist-lock enables locking between the container and an adjacent shipping container. The adjacent shipping containers may be in an end to end relationship, a side by side relationship, or a stacked relationship.

The present invention further provides in a second aspect a truck trailer configured to receive a shipping container atop of, the truck trailer including a plurality of twist-locks, each twist-lock having a rotatable locking element, and a driver for causing one or more of the locking elements to rotate for locking and unlocking the twist-lock to lock and unlock, respectively, the shipping container to the truck trailer, wherein each twist-lock is configured to receive an input signal from a remote hand-held device to operate the driver to lock or unlock the shipping container to the truck trailer.

The truck trailer may include an actuator that sends the input signal to one or more groups of the twist-locks and wherein the groups are selected to coincide with a configuration of locking recesses in different shipping containers. For example, 20 ft shipping containers have different configurations of locking recesses to 40 ft shipping containers.

The twist-locks may comprise a visual indicator that displays to an operator which of the one or more groups of twist-locks to position a container atop of.

The visual indicator may comprise a light source such as an LED.

In some embodiments, the operator is a person, for example a crane operator. However, it is also envisaged that the operator may be an artificial intelligence (AI) such as a robot that is capable of image recognition.

The present invention further provides, in a third aspect, a truck trailer configured to receive a shipping container atop of, the truck trailer including a plurality of twist-locks, each twist-lock having a rotatable locking element, and a driver for causing one or more of the locking elements to rotate for locking and unlocking the twist-lock to lock and unlock, respectively, the shipping container to the truck trailer, wherein each twist-lock has a visual indicator that displays to an operator where to position the container on the truck trailer.

The present invention further provides, in a fourth aspect, a twist-lock for locking a first shipping container to a second shipping container, the twist-lock being mountable to the first shipping container and having a rotatable locking element that is engageable with the second shipping container, and a driver for causing the locking element to rotate for locking and unlocking the twist-lock to lock and unlock, respectively, the first shipping container to the second shipping container.

The present invention further provides, in a fifth aspect, a twist-lock for locking a first shipping container to a second shipping container, the twist-lock having first and second rotatable locking elements that are engageable with a first shipping container and a second shipping container, respectively and a driver for causing the locking elements to rotate for locking and unlocking the twist-lock to lock and unlock, respectively, the first shipping container to the second shipping container.

The rotation of the first and second rotatable locking heads may be independent or in unison.

### BRIEF DESCRIPTION OF THE DRAWINGS

The invention is described further, by way of example only, with reference to the accompanying drawings, of which:

FIG. 1 is an isometric view of a twist-lock of a twist lock system according to an embodiment of the invention in an unlocked condition.

FIG. 2 is an exploded view of the twist-lock in FIG. 1.

FIG. 3 is a side elevation of the twist-lock in FIG. 1.

FIG. 4 is an isometric view of the twist-lock in FIG. 1 in a locked condition.

FIG. 5 is an isometric view of the twist-lock in FIG. 1 in a depressed position, such as when a shipping container is placed over the twist-lock and the position of the twist-lock on the trailer does not coincide with a locking recess on the shipping container.

FIG. 6 is a schematic representation of a twist-lock system, according to another embodiment of the invention, incorporated into a truck and truck trailer.

FIGS. 7A, 7B and 7C are schematic representations of a twist-lock system according to an embodiment of the present invention, the system comprising a twist-lock, a driver, and a remote hand-held device, wherein FIG. 7A shows a side view of the twist-lock according to this embodiment in an unlocked condition; FIG. 7B shows the twist-lock of FIG. 7A in a locked condition; and FIG. 7C shows the remote hand-held device.

FIGS. 8A, 8B and 8C are schematic representations of a twist-lock system according to another embodiment of the present invention in which visual indicators on the twist-locks display to an operator which twist-locks to position the container atop of; wherein FIG. 8A shows a side view of the twist-lock according to this embodiment in an unlocked condition; FIG. 8B shows a plan view of the twist-lock shown in FIG. 8A; and FIG. 8C shows a plan view of a truck trailer which includes a plurality of the twist-locks shown in FIGS. 8A and 8B.

FIGS. 9A, 9B, 9C and 9D are schematic representations of a twist-lock system for locking a plurality of shipping containers together in a stacked relationship, the plurality of shipping containers comprising a central shipping container, an upper shipping container and a lower shipping container, wherein FIG. 9A shows a configuration in which the twist-locks are disposed on a top and bottom of the central shipping container; FIG. 9B shows a configuration in which the twist lock are disposed on a top of both the central container and the lower container; FIG. 9C shows a configuration in which the twist-locks are disposed on a bottom of both the central shipping container and the upper shipping container; FIG. 9D shows a configuration in which the twist-locks are disposed on a top and bottom of lower and upper shipping containers, respectively.

FIGS. 9E, 9F, 9G and 9H are schematic representations of a twist-lock system for locking a plurality of shipping containers together in a end to end relationship which comprises a central shipping container, a right-hand-side shipping container and a left-hand-side shipping container, wherein FIG. 9E shows a configuration in which the twist-locks are disposed on both a right-hand-side and left-hand-side of the central shipping container; FIG. 9F shows a configuration in which the twist-locks are disposed on a right-hand-side of both the central shipping container and the left-hand-side shipping container; FIG. 9G shows a configuration in which the twist-locks are disposed on a left-hand-side of both the central shipping container and the right-hand-side shipping container; and FIG. 9H shows a configuration in which the twist-locks are disposed on the left-hand-side and right-hand-side of the right-hand-side and left-hand-side shipping containers, respectively.

FIGS. 10A, 10B and 10C are schematic representations of a twist-lock system according to another embodiment of the present invention, the system comprising a twist-lock having first and second rotatable locking elements, a driver, and a remote hand-held device, wherein FIG. 10A shows a side view of the twist-lock according to this embodiment in an unlocked condition; FIG. 10B shows the twist-lock of FIG. 10A in a locked condition; and FIG. 10C shows the remote hand-held device.

FIGS. 11A, 11B and 11C are schematic representations of a twist-lock system according to another embodiment of the present invention, the system comprising a twist-lock having first and second rotatable locking elements, a driver, and a remote hand-held device, wherein FIG. 11A shows a side view of the twist-lock according to this embodiment in an unlocked condition; FIG. 11B shows the twist-lock of FIG. 11A in a locked condition; and FIG. 11C shows the remote hand-held device.

FIG. 12 is a schematic representation of a twist-lock system according to another embodiment of the present invention in which a plurality of twist-locks is electrically connected in a daisy chain configuration to a group controller which is configured to wirelessly communicate with a remote hand-held device, in the form of a tablet.

FIG. 13 is a schematic representation of the group controller shown in FIG. 12.

FIG. 14 is a schematic representation of a twist-lock shown in FIG. 12 which comprises an individual controller that is configured to communicate with a group controller.

FIG. 15 is a schematic representation of a graphic user interface (GUI) on the remote hand-held device shown in FIG. 12.

### DESCRIPTION OF EMBODIMENT

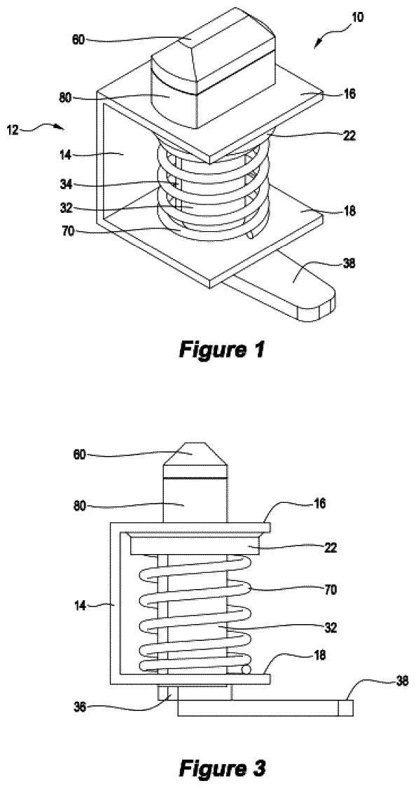

A twist lock (10) according to an embodiment of the invention is shown in FIGS. 1 to 5. The twist-lock (10) is mountable to a truck trailer via a bracket (12) and includes a locking mechanism that includes a rotatable locking element having a locking head, in the form of a cap (60). The twist lock (10) further includes a driver, in the form of an electric motor (40), it causes the cap (60) to rotate to lock and unlock the twist-lock (10) with a shipping container. The electric motor (40) operates upon receiving an input signal from a location remote from the twist-lock (10).

More specifically, and having regard to FIGS. 1 and 2, the bracket (12) includes a mounting panel (14) which is secured to a chassis or other structural part of a truck trailer whereby to secure the twist-lock (10) to the truck trailer. The bracket (12) includes an upper platform, in the form of upper panel (16) and a lower panel (18). A hole (17) passes through the upper panel (16) and is shaped with arcuate ends and parallel sides connecting the ends. The arcuate ends have a curvature which corresponds to the curvature of a sleeve (22) that extends downwardly from an underside of the upper platform (16) so that parts of the sleeve (22) are aligned with the arcuate ends of the hole (17).

The lower platform (18) is generally parallel to the upper platform (16) and includes an opening (26) that is aligned with the hole (17) in the upper platform (16). The opening (26) includes a cut out section which acts as a guide channel (28).

The electric motor (40) forms part of a locking lug which comprises a housing (32) that is formed as a generally hollow cylinder for receiving the electric motor (40). The housing (32) includes an upper flange (24) that is shaped to fit through the opening in the upper panel (16). The flange (24) includes downwardly extending side wings that define a seat (20) for an upper end of a coil spring (70). When the twist-lock (10) is assembled, an upper part of the coil spring (70) is located within the sleeve (22) and abuts the underside of the upper panel (16) so that it is compressed slightly between the upper panel (16) and the lower panel (18). The seat (20) rests on the top of the coil spring (70) so that the housing (32) is suspended within the coil spring (70) and extends downwardly through the opening (26) in the lower panel (18). A guide ridge (34) on the housing locates in the guide channel (28) to ensure that the housing (32) remains aligned with the guide ridge (34) facing the mounting panel (14) during operation of the twist-lock (10). The guide ridge (34) and guide channel (28) are configured to limit rotation of the housing (32) relative to the bracket (12). In this position, the cap (60) projects above the upper panel (16) by a distance slightly greater than the depth of a locking point of a shipping container so that the cap (60) can be actuated to lock with the locking point. Additionally, the cap (60) is biased into that position by the coil spring (70). However, the coil spring (70) allows the cap (60) to be depressed flush with the upper panel (16) by a shipping container when it is misaligned during loading. In this way, the twist-lock (10) is protected from damage during loading but re-arranges itself for locking when the shipping container is properly aligned. In practice, this means that the coil spring eliminates the need for manual readjustment in order to set up for either a 20 ft or a 40 ft long container. Typically, twist-locks known in the art have to be manually raised in order for them to be set up for locking with the container.

Although this embodiment utilises the coil spring (70) to provide the upward biasing force on the cap (60), it will be appreciated that other embodiments may use other means for upwardly biasing the cap (60). For example, the cap (60) may be biased upwardly pneumatically, hydraulically or by a deformable element. In one embodiment, the coil spring (70) may be replaced by a compressible gas strut that links the housing (32) to the lower panel (18).

A printed circuit board (44) is accommodated within the housing (32) and is electrically connected to the electric motor (40) for controlling operation of the electric motor (40).

A drive spindle (42) extends upwardly from an upper end of the electric motor (40). The drive spindle (42) passes through a motor mount bracket (46) and into a locking ring (62) to which the motor mount bracket (46) is fastened by screws. The drive spindle (42) has a D-shaped profile which corresponds with the profile of a central hole passing through the locking ring (62) such that operation of the electric motor (40) causes the motor mount bracket (46) and the locking ring (62) to rotate with the motor. Limit switches (50) are fastened to respective stubs (48) which project from the motor mount bracket (46) and are circumferentially disposed around the axis of the drive spindle (42) at intervals of approximately 90° to each other.

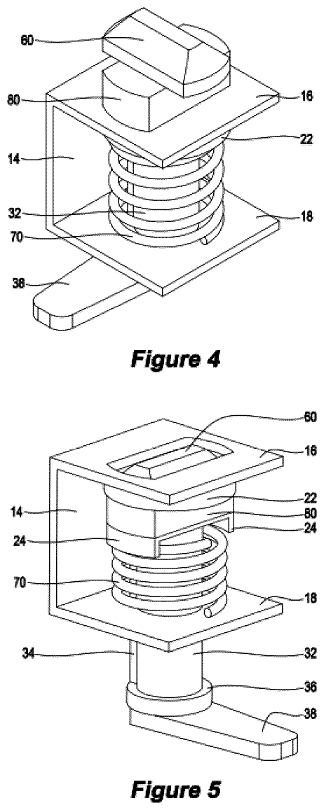

When assembled, the spindle (42), motor mount bracket (46) and locking ring (62) are housed within the collar (80) which is fixed to an upper side of the flange (24). The collar (80) includes an aperture (82) aligned with the drive spindle (42) so that the locking ring (62) can be fastened to the cap (60) and, therefore, operation of the electric motor (40) causes the cap (60) to rotate. The limits switches (50) are configured on the motor mount bracket to contact an interior surface of the collar (80) so as to discontinue rotation of the cap (60) relative to the collar (80). As the limit switches (50) are aligned roughly perpendicularly to each other, rotation of the cap (60) is limited to the same extent. For example, FIG. 1 shows the cap (60) aligned with the collar so that both the cap (60) and the collar (80) are able to pass through an opening in a locking point of a shipping container. FIG. 4, however, shows the locking cap (60) rotated through approximately 90° so that the cap (60) overlaps a shoulder of a locking point on the shipping container. When the cap (60) overlaps the shoulder, the twist-lock (10) mechanically locks with the shipping container and, therefore, it is considered to be in a locked position. By way of contrast, FIG. 1 shows the twist-lock (10) in the unlocked position.

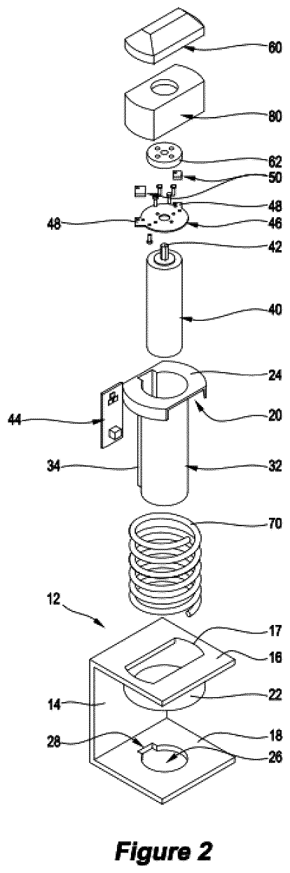

The twist lock (10) further includes a flange (36) (FIGS. 3 and 5) that extends radially outwardly from the housing (32) so that the flange (36) is unable to fit through the aperture (26) in the lower platform (18). In this way, the housing (32) is mechanically locked with the bracket (12). The mechanical locking is completed by the fact that the flange (24) on the top of the housing is unable to pass through the opening (26) even if the spring (70) could be compressed to that extent.

Additionally, the twist-lock (10) includes an arm in the form of a handle (38) (FIGS. 1, 3, 4 and 5). The handle (38) is linked to the electric motor and rotates in unison with the cap (60). However, the handle (38) is aligned generally perpendicularly to the cap (60) so that in the unlocked position (FIG. 1), the handle (38) extends away from the mounting panel (14). This places the handle (38) outside the width extremity of the trailer and therefore becomes visible to a truck driver from the cabin of a truck. When the twist-lock (10) is in the locked position (FIG. 4), the handle (38) extends parallel to the mounting panel (14) and is contained within the width extremity of the truck trailer. As a result, the handle (38) is not visible to the truck driver from the cabin of the truck and therefore provides visual indication of the locking status of the twist-lock (10).

A truck trailer will include a number of twist-locks (10) to coincide with the different configurations of locking points that are associated with shipping containers of different sizes. For example, a truck trailer may have 14 or more twist-locks (10) to accommodate shipping containers that have 4 or 8 locking points. As a result, some twist-locks (10) when fitted to a truck trailer will not coincide with a locking point on a shipping container. To account for this, the housing (32), collar (80) and cap (60) are all formed to move generally vertically within the bracket and yet remain generally vertically aligned. Specifically, the coil spring (70) is compressed (FIG. 5) by the weight of a shipping container bearing on the cap (60) which is depressed to be generally level with the upper panel (16). As a result, the collar (60) is pushed downwardly within the sleeve (22). The curvature of the sleeve (22) is generally consistent with the curvature of the arcuate ends of the collar (80) so that the collar remains generally vertically aligned within the sleeve (22). Furthermore, the housing (32) extends downwardly through the opening (26) in the lower panel (18). The twist-lock (10) remains in this position until the shipping container is removed from the truck trailer. At that time the upward biasing force provided by the coil spring (70) causes the collar (80) and cap (60) to project once more above the level of the upper panel (16).

Similar action occurs when a shipping container is lowered onto the truck trailer and when the locking points are not properly aligned with the twist-locks (10). When the locking points are ultimately aligned, the coil spring (70) pushes the collar (80) and the cap (60) upwardly into the locking points so the twist-lock (10) can be operated to lock the truck trailer to the shipping container.

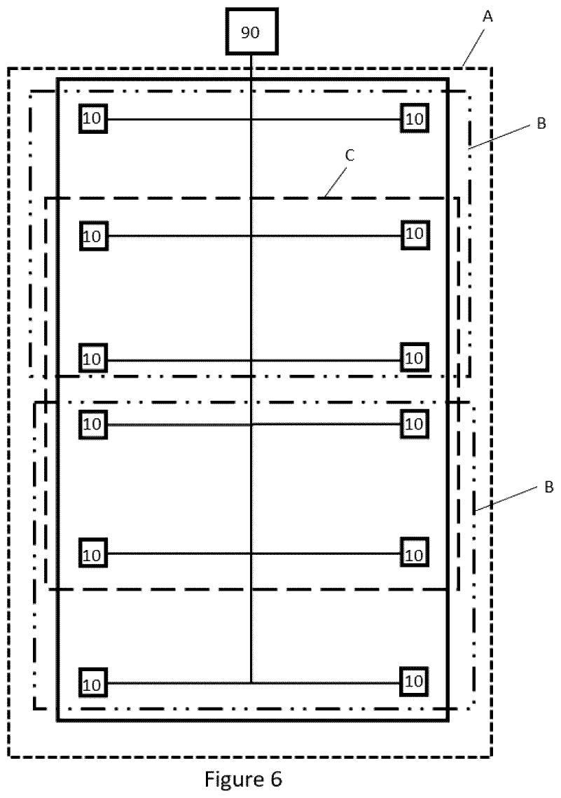

As shown in FIG. 6, each twist-lock (10) is connected by electrical cable to an input terminal (90), for example a control panel, located remotely from the twist-locks (10). Specifically, the input terminal (90) may be located in the cabin of a truck so that the truck driver can operate the twist-locks remotely from the cabin of the truck. There is considerable convenience associated with operating the twist-locks (10) from the cabin because it reduces the overall time to secure the shipping container to the truck trailer.

According to one embodiment, the twist-locks (10) can be operated simultaneously in groups. For example, groups contained within respective dashed lines marked A, B and C in FIG. 6 may be operated independently of each other, but with the twist-locks (10) in each group being operated simultaneously. In this example, the group of twist-locks (10) within the dashed lines marked “A” correspond to the locking recesses on a 40 ft long shipping container and the group of twist-locks (10) within the dashed lines marked “B” and “C” correspond to the locking recess on 20 ft long shipping container. Groups “B” and “C” represent two different arrangements of locking recesses for 20 ft long shipping containers.

Although the twist-locks (10) are shown in FIG. 6 as being connected to the terminal input (90) by wire, i.e. electrical cable, it will be appreciated that the connection may be instead by wireless communication means, such as Wi-Fi, Bluetooth® or any other means of wireless communications.

In an alternative form, the twist-locks (10) may be connected by wire to an actuator terminal fitted to a truck trailer. Communication of a signal from the terminal input (90) to the twist-locks (10) may be via wireless communication means from the input terminal (90) to the actuator and then by wire to the twist-locks (10).

In a further alternative, the twist-locks (10) may be fitted with sensors to indicate a status condition of the twist-locks and that information may be communicated to the terminal input (90) via the wired or wireless communication means. In this way, the truck driver can monitor the status of the twist-locks (10) to ensure that they are locked or unlocked, as required.

In yet another alternative, the electric motors (40) may be substituted for pneumatic or hydraulic drivers for causing rotation of the cap (60).

In the event that the power supply to the electric motors (40) fails so that the twist-locks (10) cannot be moved to a locked or unlocked position, the twist-locks (10) include a trigger that releases the drive spindle (42) from the locking ring (62). However, the handle (38) remains mechanically linked to the cap (60) so that operation of the handle (32) manually operates the cap (60) to lock or unlock from a shipping container.

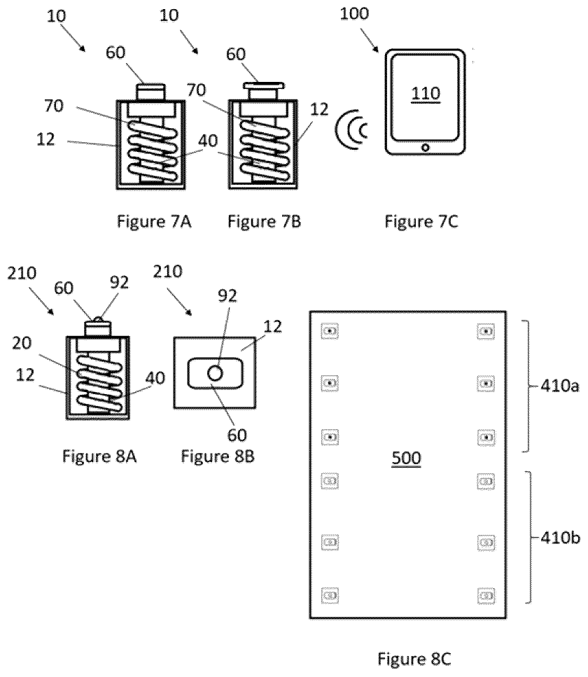

FIG. 7 shows a twist-lock system (10, 100) that comprises a twist-lock (10), as shown in FIGS. 7A and 7B, and a hand-held remote device, in the form of a smart-phone/tablet (100), as shown in FIG. 7C.

The twist-lock (10) operates in the same manner as described above with the exception that the electric motor (40) is operated upon receiving an input signal from the smart-phone/tablet (100). The smart-phone/tablet (100) has a display (110) having a graphical user interface (GUI) on which an app can be operated to send an input signal to operate the driver of the twist-lock (10).

A twist lock (210) according to an embodiment of the invention is shown in FIGS. 8A, 8B and 8C. The twist-lock (210) has the same features as the above described twist-lock (10) but differs from the above described twist-lock (10) in that it includes a visual indicator in the form of an LED light (92) disposed on the cap (60).

FIG. 8C shows a truck trailer (500) configured to receive a shipping container atop of. The truck trailer (500) has a plurality of twist-locks (410a, 410b) each having the features as described above. The truck trailer can receive a plurality of shipping containers, wherein groups of twist-locks (410a, 410b) coincide with the configuration of locking recesses in different shipping containers. The LED lights (92) display to an operator, such as a crane operator, which of the groups of twist-locks (410a, 410b) to position the container atop of. FIG. 8C shows a first group (410a) of six twist-locks (210) in which the LED lights (92) are OFF and a second group (410b) of six twist-locks in which the LED lights (92) are ON. In this scenario, the operator could be directed to position the container atop of one of the first or second group (410a, 410b) of twist-locks.

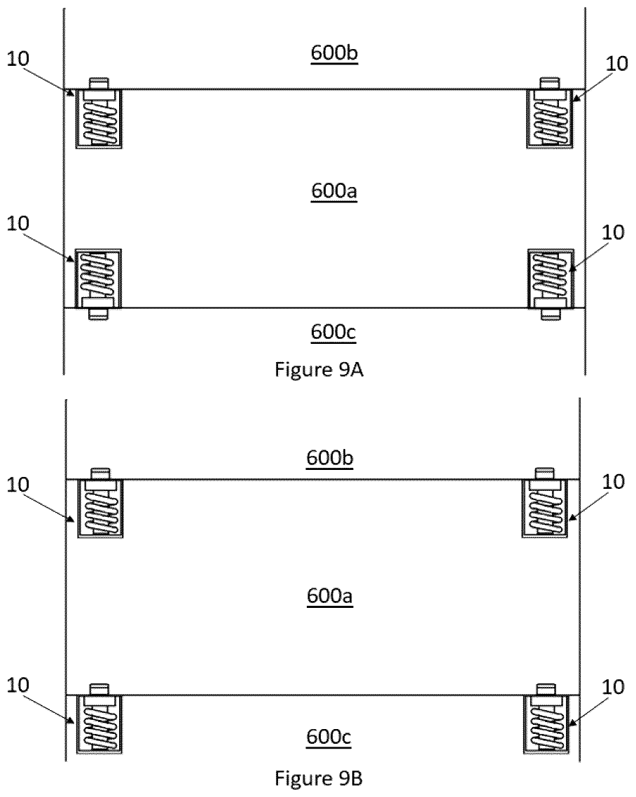

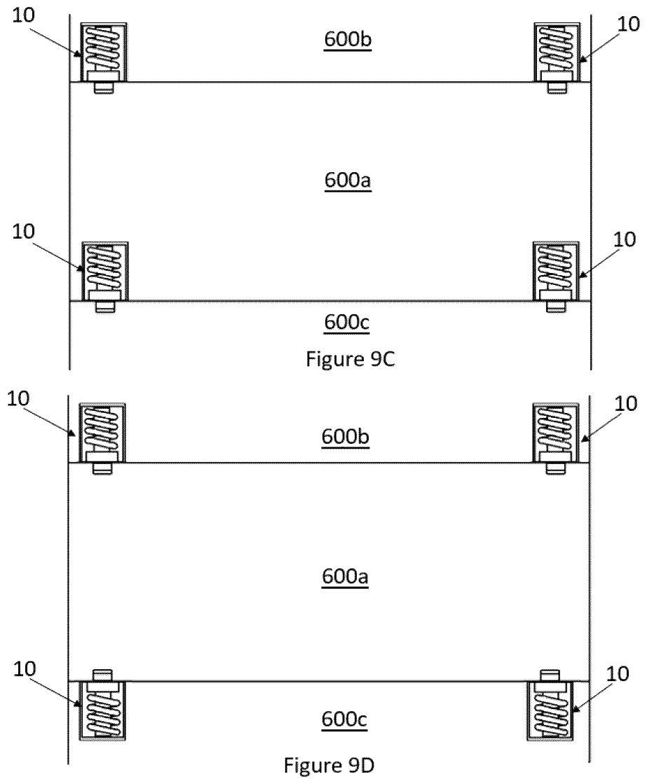

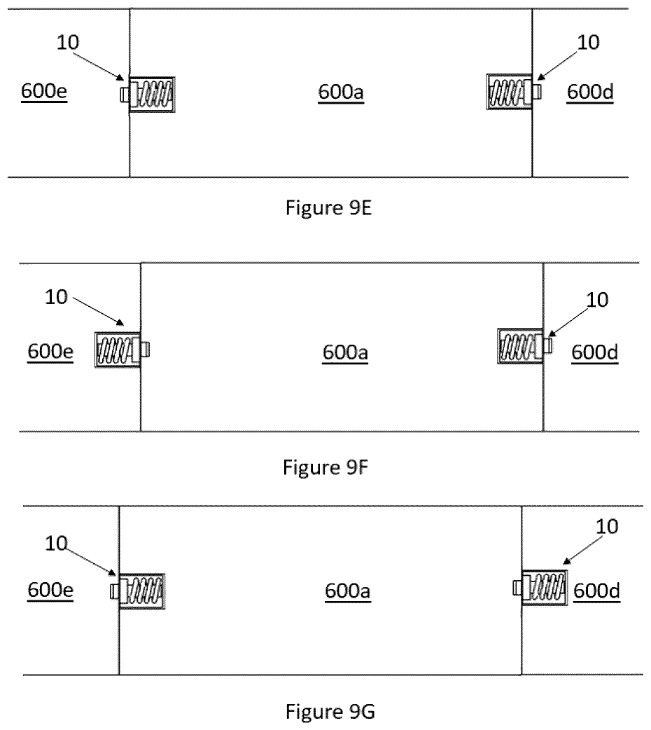

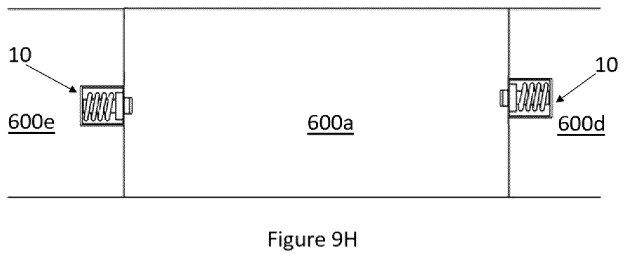

FIGS. 9A, 9B, 9C, 9D, 9E, 9F, 9G, 9H show different arrangements of twist-locks (10) for enabling locking between adjacent shipping containers. FIGS. 9A, 9B, 9C and 9D show a plurality of shipping containers in a stacked relationship. The plurality of shipping containers comprises a central shipping container (600a), an upper shipping container (600b) and a lower shipping container (600c). In the embodiment shown in these figures, the twist-locks (10) are configured to enable locking of the shipping containers in the stacked relationship.

FIG. 9A shows a configuration in which the twist-locks (10) are disposed on a top and bottom of the central shipping container (600a).

FIG. 9B shows a configuration in which the twist locks (10) are disposed on a top of both the central container (600a) and the lower container (600c).

FIG. 9C shows a configuration in which the twist locks (10) are disposed on a bottom of both the central shipping container (600a) and the upper shipping container (600c).

FIG. 9D shows a configuration in which the twist-locks (10) are disposed on a top and bottom of lower and upper shipping containers (600c, 600d), respectively.

FIGS. 9E, 9F, 9G and 9H show a plurality of shipping containers in an end to end relationship, the shipping containers comprising a central shipping container (600a), a right-hand-side shipping container (600d) and a left-hand-side shipping container (600e).

FIG. 9E shows a configuration in which the twist-locks (10) are disposed on both a right-hand-side and a left-hand-side of the central shipping container (600a).

FIG. 9F shows a configuration in which the twist-locks (10) are disposed on a right-hand-side of both the central shipping container (600a) and the left-hand-side shipping container (600e).

FIG. 9G shows a configuration in which the twist-locks (10) are disposed on a left-hand-side of both the central shipping container (600a) and the right-hand-side shipping container (600d).

FIG. 9H shows a configuration in which the twist-locks (10) are disposed on the left-hand-side and right-hand-side of the right-hand-side and left-hand-side shipping containers (600d, 600e), respectively.

As can be appreciated, the above described embodiment for enabling locking between adjacent shipping containers may be used in conjunction with a truck trailer including a plurality of twist-locks.

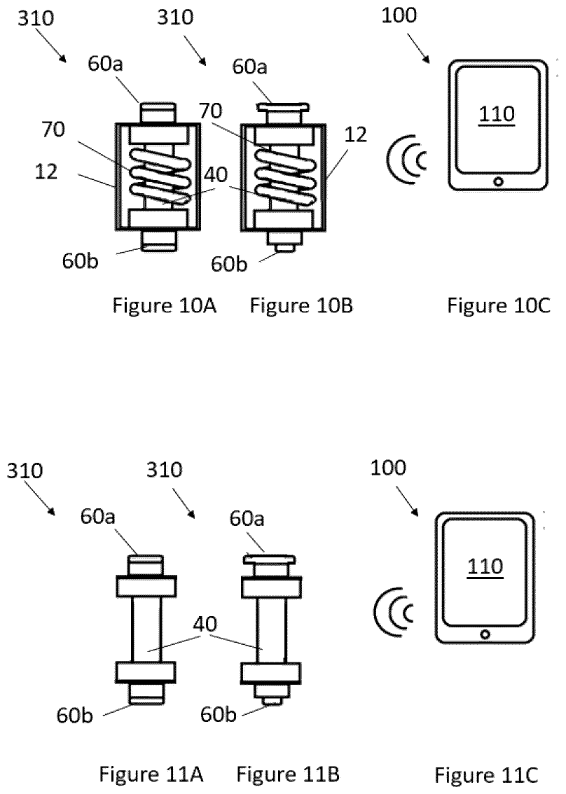

FIG. 10 shows a twist-lock system (310, 100) that comprises a twist-lock (310), as shown in FIGS. 10A and 10B, and a hand-held remote device, in the form of a smart-phone/tablet (100), as shown in FIG. 10C. The twist-lock (310) has the same features as the above described twist-lock (10) but with the exception that its locking mechanism includes oppositely facing first and second rotatable locking elements, in the form of a first cap (60a) and a second cap (60b). The first cap (60a) and second cap (60b) can be respectively received in corresponding locking recesses in a first and second shipping container. The electric motor (40) causes the caps (60a, 60b) to rotate to lock and unlock the twist-lock (310) with the first shipping container and the second shipping container. The electric motor (40) operates upon receiving an input signal from a location remote from the twist-lock (310).

The twist-lock (310) may also be mountable to a structure, such as a truck trailer, via a bracket (12), as described with reference to the embodiment shown in FIGS. 1 to 5.

However, it is also envisaged that in some embodiments, the twist-lock (310) may not need to be mounted to a structure and therefore the bracket (12) can be omitted altogether. In addition, if the bracket (12) is omitted, the coil spring (70) can also be dispensed with, because the coil spring (70) acts to bias the cap (60) relative to an upper panel (16) of the bracket (12). FIG. 11 shows a twist-lock system (310, 100) in line with the above described features.

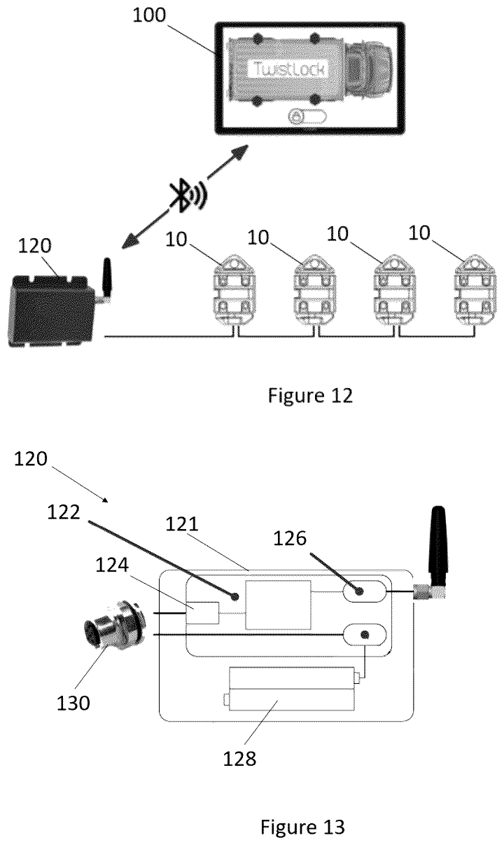

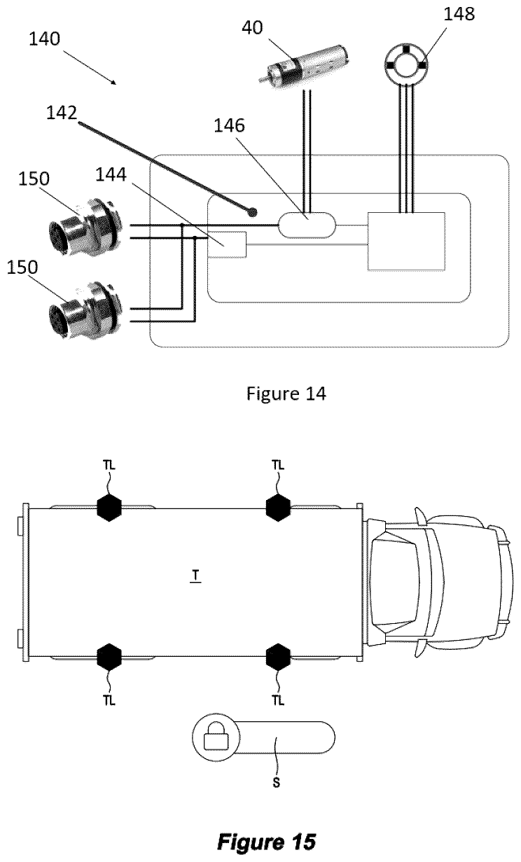

FIGS. 12-15 show a twist-lock system according to an embodiment of the invention in which a plurality of twist-locks (10) are electrically connected in a daisy chain configuration to a group controller (120). Each twist-lock (10) has an individual controller (140, see FIG. 14) that communicates with the group controller (120) via a wired connection. The group controller (120) is configured to wirelessly communicate, via Bluetooth®, with a remote hand-held device, in the form of a tablet (100) with a touch screen.

As shown in FIG. 13, the group controller (120) comprises a housing (121) which contains a circuit board (122) housing a Local Interconnect Network (LIN) physical interface (124), that operates at up to 20 kbps at a distance of up to 40 m, a Bluetooth® module (126) and a power supply (128). The LIN physical interface (124) of the group controller (120) comprises waterproof M12 connectors (130) configured for attachment with cables for providing the daisy chain configuration with corresponding connections on the individual controllers (140) of the twist-locks (10).

FIG. 14 shows the individual controller (140) of twist-lock (10). The individual controller (140) is housed within the twist-lock (10). The individual controller (140) comprises a circuit board (142) housing a LIN physical interface (144), a motor drive (146), that controls an electric motor (40) as previously described with reference to FIGS. 1-5, and limit switches (148). The limit switches (148) function in a similar manner to the limit switch (48) described with reference to the embodiment shown in FIG. 2. However, the limit switches (148) of the embodiment shown in FIGS. 12-15 are Hall effect switches that are resistively encoded to the circuit board to reduce wiring. Hall effect switches are switches that operate using an external magnetic field. Unlike Reed switches, which also operate using an external magnetic field, Hall effect switches do not have any mechanical moving parts and instead require an electrical circuit. As such, Hall effect switches are generally considered more reliable than Reed switches. This is particularly true for high vibration environments found on truck trailers. The LIN physical interface (144) of the individual controller (140) comprises waterproof M12 connectors (150) configured for attachment with cables for providing the daisy chain configuration with corresponding connectors (130) on LIN physical interfaces (124) of the group controller (120).

FIG. 15 shows a graphic user interface (GUI) on the tablet (100) shown in FIG. 12. The GUI shows a graphic representation of a truck trailer (T) with a plurality of twist-locks (TL) and a slide bar (S). The twist-locks (TL) to be locked or unlocked are selected by touching the graphic representation of the respective twist-locks (TL). Moving the graphical slide bar (S) from left to right on the touch screen of the tablet (100), moves the selected twist-locks (TL) from a locked condition to an unlocked condition. Conversely, moving the graphical slide bar (S) from right to left, moves the selected twist-locks (TL) from the unlocked condition to the locked condition. The status (locked or unlocked) of the twist-locks (TL) is displayed on the GUI, for example by changing the colour of the respective twist-lock (TL).

Many modifications may be made to the preferred embodiment of the present invention as described above without departing from the spirit and scope of the present invention.

For example, the electric motor (40) may be substituted for pneumatic or hydraulic drivers for causing rotation of the cap (60).

In addition, whilst the embodiment of FIGS. 9A-9H has been described as including the twist-lock (10), it is also envisaged that other twist-locks (210, 310) described in this application may also be incorporated into these twist-lock systems.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose.

Terms such as “front” and “rear”, “inner” and “outer”, “above”, “below”, “upper” and “lower” and the like are used as words of convenience to provide reference points and are not to be construed as limiting terms. The terms “vertical” and “horizontal” when used in reference to the twist-lock throughout the specification, including the claims, refer to orientations relative to the normal operating orientation of a twist-lock.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s).

Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

1. A twist-lock system for locking a shipping container to a structure, the system including:
(a) a twist-lock having a rotatable locking element,
(b) a driver for causing the locking element to rotate for locking and unlocking the twist-lock to lock and unlock, respectively, the shipping container to the structure, and
(c) a remote hand-held device for generating an input signal to operate the driver.

2. The twist lock system defined in claim 1, wherein the remote hand-held device is a smartphone, tablet, laptop, or control panel.

3. The twist-lock system defined in claim 1, wherein the locking element comprises a locking head and a stem.

4. The twist-lock system defined in claim 3, wherein the twist lock includes a locking lug which includes a collar to which the driver is connected such that the locking head is rotatable relative to the collar and the locking head and collar have the same profile of a locking recess on a shipping container so that the collar and the locking head are receivable in the locking recess.

5. The twist-lock system defined in claim 4, wherein the twist-lock includes a bracket in which the locking lug is mechanically locked and wherein the locking head and at least a portion of the collar project above an upper platform of the bracket.

6. The twist-lock system defined in claim 5, wherein the locking lug is able to move generally vertically relative to the bracket and wherein the vertical movement is limited by the mechanical locking of the locking lug to the bracket and wherein the locking lug is biased upwardly relative to the bracket to cause the collar and locking head to project into the locking recess of a shipping container when the locking recess is aligned with the locking head and collar.

7. The twist-lock system defined in claim 6, wherein the upper platform includes a downwardly depending sleeve having an inner profile that guides generally vertical movement of the collar within the sleeve, and therefore guides generally vertical movement of the locking lug within the bracket.

8. The twist-lock system defined in claim 6, wherein the upward bias is provided pneumatically, hydraulically or by a coil spring or a deformable element disposed between the locking lug and the bracket.

9. The twist-lock system defined in claim 3, wherein the driver is configured to cause rotation of the locking head between an unlocked position in which its profile is aligned with the profile of the collar to an unlocked position in which the profiles of the collar and the locking head are generally perpendicular.

10. (canceled)

11. The twist-lock system defined in claim 1, wherein the twist-lock is disposed on a rail transport vehicle such that the twist-lock enables locking of the shipping container to the rail transport vehicle.

12. The twist-lock system defined in claim 3, wherein the twist-lock is disposed on a truck trailer such that the twist-lock enables locking of the shipping container to the truck trailer.

13. The twist-lock system defined in claim 12, comprising an actuator that sends input signals to the twist-locks via a wired or wireless communication to operate the respective drivers and an input terminal that is remote from the twist-locks and which receives inputs from a truck driver and transmits an operation signal to the actuator whereby to operate the respective drivers to lock or unlock a shipping container with the truck trailer.

14. The twist-lock system defined in claim 13, wherein the input terminal is located in the cabin of a truck and is in communication with the twist-locks.

15. The twist-lock system defined in claim 13, wherein the system includes an actuator on the truck trailer that receives a signal from the input terminal and sends input signals to the twist-locks to operate the respective drivers.

16. The twist-lock system defined in claim 13, wherein the twist-locks provide a status feedback signal to the input terminal to indicate a status condition of a twist-lock.

17. The twist-lock system defined in claim 16, wherein the status feedback signal is provided to the input terminal via the actuator.

18. (canceled)

19. The twist-lock system defined in claim 12, wherein the twist-lock includes an arm linked to the driver to rotate in unison with the locking head and wherein the arm is configured to provide a visual indication of the position of the locking head.

20. (canceled)

21. The twist-lock system defined in claim 1, wherein the twist-lock is disposed on a container such that the twist-lock enables locking between the container and an adjacent shipping container.

22. A truck trailer configured to receive a shipping container atop of, the truck trailer including a plurality of twist-locks, each twist-lock having a rotatable locking element, and a driver for causing one or more of the locking elements to rotate for locking and unlocking the twist-lock to lock and unlock, respectively, the shipping container to the truck trailer, wherein each twist-lock is configured to receive an input signal from a remote hand-held device to operate the driver to lock or unlock the shipping container to the truck trailer.

23. (canceled)

24. (canceled)

25. (canceled)

26. A truck trailer configured to receive a shipping container atop of, the truck trailer including a plurality of twist-locks, each twist-lock having a rotatable locking element, and a driver for causing one or more of the locking elements to rotate for locking and unlocking the twist-lock to lock and unlock, respectively, the shipping container to the truck trailer, wherein each twist-lock has a visual indicator that displays to an operator where to position the container on the truck trailer.

27. (canceled)

28. (canceled)
